(19) United States
(12) Patent Application Publication
(10) Pub. No.: US 2009/0279035 A1
(43) Pub. Date: Nov. 12, 2009

(54) Antiglare Film

(75) Inventors: Takahiro Morinaga, Tokyo (JP); Yusuke Tochigi, Tokyo (JP); Hideaki Honma, Tokyo (JP); Takashi Nishihara, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/434,591

(22) Filed: May 1, 2009

(30) Foreign Application Priority Data
May 9, 2008 (JP) 2008-123121

(51) Int. Cl. G02F 1/1335; G02B 1/11; B05D 5/06

(52) U.S. Cl. 349/137; 359/601; 427/164

(57) ABSTRACT

The present invention provides an antiglare film which has (1) appropriate antiglare properties in a frontal direction, (2) no white-blurring (3) no surface appearance such as a kind of orange on the surface of an antiglare layer's side. It is a feature of the antiglare film of the present invention that it has an antiglare layer on a transparent substrate and the antiglare layer includes a binder matrix and particles of an acrylate-styrene copolymer. In addition, the binder matrix includes an acrylic material having a hydroxyl group, a quotient (R_{A}/H) obtained by dividing the average diameter of the particle (R_{A}) by the average thickness of the antiglare layer (H) is in the range of 0.30-0.80, and a product ((n_{A}−n_{M})×w_{A}/w_{M}) obtained by multiplying a difference between the refractive index of the particles (n_{A}) and the average refractive index of the binder matrix (n_{M}) by a quotient dividing the content of the particles in the antiglare layer (w_{A}) by the content of the binder matrix in the antiglare layer (w_{M}) is in the range of 0.0015-0.003.

### CROSS REFERENCE TO RELATED APPLICATION

This application is based on and claims the benefit of priority from the Japanese Patent Application number 2008-123121, filed on May 9, 2008, the entire contents of which are incorporated herein by reference.

### BACKGROUND OF THE INVENTION

1. Field of the Invention

This invention relates to an antiglare film which is applied on a surface of a window or a display etc. In particular, this invention relates to an antiglare film which is used on a surface of a display such as liquid crystal display (LCD), CRT (Cathode Ray Tube) display, organic electroluminescent display (OELD), plasma display (PDP), surface conduction electron-emitter display (SED) and field emission display (FED) etc.

2. Description of the Related Art

In the field of displays such as LCD, CRT display, ELD and PDP, an arrangement of an antiglare film which has a concave-convex structure on the surface thereof on the display is known as a means for preventing a degradation of visibility caused by reflection of external light on the display surface during watching.

The following techniques, for example, are known for producing such antiglare films:
a method of forming a concave-convex structure on an antiglare film surface by emboss processing;
a method of coating a coating liquid obtained by admixing particles to a binder matrix forming material and dispersing the particles in the binder matrix, thereby forming a concave-convex structure on an antiglare film surface.

In such an antiglare film having on the surface thereof a concave-convex structure formed by the above-described methods, external light falling on the antiglare film is scattered by the concave-convex structure of the surface. As a result, the image of external light becomes smudgy so that the degradation of visibility caused by the reflection of external light on the display surface is prevented.

In the antiglare film in which convexities and concavities have been formed on the surface by emboss processing, surface convexities and concavities can be completely controlled. As a result, reproducibility is good. However, the problem is that when defects or foreign matters are present on the emboss roll, the defects spaced by a roll pitch appear on the film continuously.

On the other hand, the antiglare film using a binder matrix and particles can be produced by using fewer operations than the antiglare film employing the emboss processing. As a result, this type of antiglare film can be manufactured at a low cost. Accordingly, antiglare films of a variety of forms in which particles are dispersed in a binder matrix are known (Japanese Patent Application Publication No. 6-18706 (JP-A-6-18706)).

Various techniques have been disclosed with respect to antiglare films using a binder matrix and particles. For example, the following methods for producing antiglare films using a binder matrix and particles have been disclosed:
a method using a binder matrix resin, spherical particles, and particles of irregular shape (JP-A-2003-260748);
a method using a binder matrix resin and particles of a plurality of different diameters (JP-A-2004-004777);
a method of using a film having surface convexities and concavities in which the cross-sectional area of convexities is specified (JP-A-2003-004903).

In addition, the following methods have also been disclosed:
a method of using internal scattering in combination with external scattering and setting an internal haze of an antiglare film to 1-15% and a surface haze to 7-30% (JP-A-11-305010);
a method of using a binder resin and particles with a size of 0.5-5 μm, setting the difference in refractive index between the resin and the particles to 0.02-0.2, and compounding particles more than 10 parts by weight and less than 30 parts by weight relative to 100 parts by weight of resin (JP-A-4001320);
a method of using a binder resin and particles with a size of 1-5 μm and setting the difference in refractive index between the resin and the particles to 0.05-0.15, and a method in which the properties of the solvent used and the surface roughness are set within the predetermined ranges (JP-A-2000-338310);
a method of using a binder resin and a plurality of particles and setting the difference in refractive index between the resin and the particles to 0.03-0.2 (JP-A-2000-180611);
a method of setting a surface haze to 3 or more and setting the difference between a haze value in the normal direction and a haze value in the direction at ±60° to 4 or less with the object of reducing the variations in hue and decrease in contrast occurring when the viewing angle changes (JP-A-11-160505).

As described above, various techniques for various purposes have been disclosed. Required properties and performances for an antiglare film which is applied on a frontal surface of a display device depend on the type of the display. In other words, the most desirable antiglare film for a display device differs depending on the display's resolution and intended use etc. Therefore, a wide variety of antiglare films to meet various applications are wanted.

### SUMMARY OF THE INVENTION

An antiglare film is applied on a display surface of a notebook computer, a desktop PC or a TV monitor. As TV monitors are often watched from a considerable distance in recent years, the antiglare film is required to have not only an antiglare property which prevents external light from falling on the display surface but also a high level of visibility which allows the display to have a high contrast performance.

Thus, an antiglare film for a display of a TV monitor that (1) has an adequate antiglare property which makes an image of external light incident on a surface of a display in a frontal direction (namely, in a perpendicular direction to the display surface) blurred so that external light cannot fall on the display, (2) does not decrease the contrast of an image on the display so that no whitening phenomena (white-blurring) is shown when illumination of fluorescent light is incident on the film, and (3) does not have a citrus-skin-like structure on the surface of the antiglare layer side in order to realize high visibility, is demanded. This invention provides an antiglare film having (1) an appropriate antiglare property in a frontal direction, (2) no white-blurring, and (3) no citrus-skin-like appearance on the surface of the antiglare layer side. In addition, this invention provides a transmission type LCD employing such an antiglare film.

A first aspect of the present invention is an antiglare film for providing such an antiglare film and LCD which has an antiglare layer on a transparent substrate and specific features as follows: The antiglare layer has a concave-convex structure on the opposite side from the transparent substrate. The antiglare layer includes acrylate-styrene copolymer particles in the binder matrix thereof. The binder matrix includes an acrylic material having a hydroxyl group. A quotient R_{A}/H which is obtained by dividing an average diameter of the acrylate-styrene copolymer particles (R_{A}) by an average thickness of the antiglare layer (H) is in the range of 0.30-0.80. A quotient (n_{A}−n_{M})w_{A}/w_{M} which is obtained by multiplying a difference between a refractive index of the acrylate-styrene copolymer particles and an average refractive index of the binder matrix by a quotient of a content of the acrylate-styrene copolymer particles by a content of the binder matrix in the antiglare layer being in the range of 0.0015-0.003.

In addition, a second aspect of the present invention includes the antiglare film in accordance with the first aspect of the present invention, wherein the acrylic material having a hydroxyl group is pentaerythritol triacrylate, and the antiglare layer contains more than (or equal to) 18 parts by weight of pentaerythritol triacrylate against 100 parts by weight of the binder matrix.

In addition, a third aspect of the present invention includes the antiglare film in accordance with the first aspect of the present invention, wherein the average thickness of the antiglare layer (H) is in the range of 3-30 μm.

In addition, a fourth aspect of the present invention includes the antiglare film in accordance with the first aspect of the present invention, wherein the transparent substrate is a triacetyl cellulose film.

In addition, a fifth aspect of the present invention includes the antiglare film in accordance with the first aspect of the present invention, wherein the thickness of the transparent substrate is in the range of 10-100 μm.

In addition, a sixth aspect of the present invention includes a transmission type LCD which has the antiglare film in accordance with any aspect from the first to the fifth aspect of the present invention, a first polarizing plate, a liquid crystal cell, a second polarizing plate, and a back light unit in the order of this description from an observer's side, and further, the antiglare layer of the antiglare film is arranged on a surface of the observer's side.

In addition, a seventh aspect of the present invention includes a polarizing plate which has the antiglare film in accordance with any aspect from the first to the fifth aspect of the present invention, a polarizing layer and a second transparent substrate in the order of this description, and further, the polarizing layer is arranged on the opposite side of the transparent substrate of the antiglare film from a side on which the antiglare layer is formed.

In addition, a eighth aspect of the present invention includes a transmission type LCD which has the polarizing plate in accordance with the seventh aspect of the present invention, a liquid crystal cell, another polarizing plate, and a back light unit in the order of this description from an observer's side, and further, the antiglare layer of the antiglare film is arranged on the surface of the observer's side.

In addition, a ninth aspect of the present invention is a manufacturing method of an antiglare film having particles in a binder matrix on a transparent substrate which has a specific features as follows: The manufacturing method includes coating a coating liquid for forming an antiglare layer which contains at least the binder matrix, acrylate-styrene copolymer particles and a solvent to form a coated layer; drying the coated layer to remove the solvent; and curing the binder matrix forming material to form the binder matrix by exposing the coated layer to ionizing radiation. Furthermore, in the manufacturing method, the binder matrix forming material includes an acrylic material having a hydroxyl group, a quotient R_{A}/H obtained by dividing the average diameter of the acrylate-styrene copolymer particles (R_{A}) by the average thickness of said antiglare layer (H) is in the range of 0.30-0.80, and a product (n_{A}−n_{M})×w_{A}/w_{M} obtained by multiplying a difference between the refractive index of the acrylate-styrene copolymer particles and the average refractive index of the binder matrix (n_{A}−n_{M}) by a quotient of dividing the content of the acrylate-styrene copolymer particles (w_{A}) by the content of the binder matrix (w_{M}) is in the range of 0.0015-0.003.

In addition, a tenth aspect of the present invention includes the manufacturing method in accordance with the ninth aspect of the present invention, wherein the transparent substrate is a triacetyl cellulose film, and the solvent, which is included in the coating liquid for forming an antiglare layer, includes a mixed solvent of a solvent in which the triacetyl cellulose film is dissolved or swollen and a solvent in which the triacetyl cellulose film is not dissolved or swollen.

In addition, an eleventh aspect of the present invention includes the manufacturing method in accordance with the tenth aspect of the present invention, wherein the solvent in which the triacetyl cellulose film is dissolved or swollen includes a cyclic ether compound.

The present invention briefly described above provides an antiglare film which has <1> adequate antiglare properties in frontal direction, <2> no white-blurring phenomenon, and <3> no citrus-skin-like appearance on a surface on which an antiglare layer is arranged, and therefore the antiglare film is desirable for an application to a TV monitor display.

### BRIEF DESCRIPTION OF THE DRAWINGS

FIG. 1 shows a cross sectional diagram of an antiglare film of the present invention when an acrylate-styrene copolymer is used as an antiglare layer forming material.

FIGS. 2A and 2B show a transmission type LCD using the antiglare film of the present invention.

FIG. 3 illustrates an exemplary diagram of the coating machine using a die coater of the present invention.

### DESCRIPTION OF REFERENCE NUMERALS AND SIGNS

1: Antiglare film
11: Transparent substrate
12: Antiglare layer
120: Binder matrix
121: Acrylate-styrene copolymer particles
R_{A}: Average diameter of particles A
H: Average thickness of antiglare layer
2: Polarizing plate
21: Transparent substrate
22: Transparent substrate
23: Polarizing layer
3: Liquid crystal cell
41: Transparent substrate
42: Transparent substrate
43: Polarizing layer
5: Back light unit
30: Die head
31: Pipework
32: Tank of coating liquid
33: Liquid sending pump
35: Rotary roll

### DETAILED DESCRIPTION OF THE INVENTION

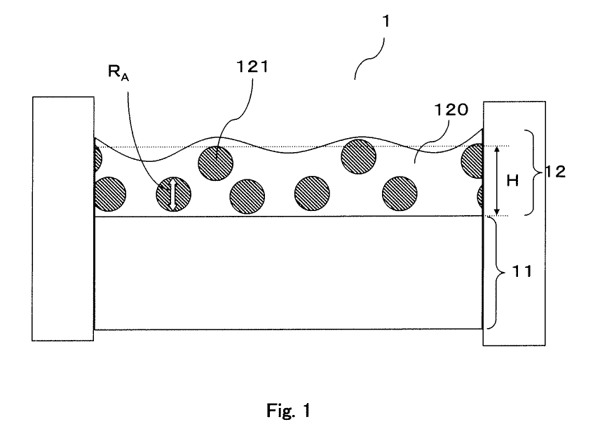

The antiglare film of the present invention is described below. A cross sectional view of the antiglare film of the present invention is shown in FIG. 1. The antiglare film (1) of the present invention has an antiglare layer (12) on at least one side of a transparent substrate (11). The antiglare layer (12) of the antiglare film (1) of the present invention includes a binder matrix (120) and particles of an acrylate-styrene copolymer (121).

It is a specific feature of the antiglare film of the present invention that <a> the antiglare layer includes a binder matrix and particles of an acrylate-styrene copolymer, and the binder matrix includes an acrylic material having a hydroxyl group; <b> a quotient (R_{A}/H) obtained by dividing an average diameter of the particles of an acrylate-styrene copolymer (R_{A}) by an average thickness of the antiglare layer (H) is in the range of 0.30-0.80; and <c> a product ((n_{A}−n_{M})×w_{A}/w_{M}) obtained by multiplying a difference between the refractive index of the particles (n_{A}) and the average refractive index of the binder matrix (n_{M}) by a quotient dividing the content of the particles in the antiglare layer (w_{A}) by the content of the binder matrix in the antiglare layer (w_{M}) is in the range of 0.0014-0.0030.

It is a feature of the antiglare film of the present invention that <a> the antiglare layer includes a binder matrix and particles of an acrylate-styrene copolymer, and the binder matrix includes an acrylic material having a hydroxyl group.

An antiglare film has a concave-convex structure on a surface of the antiglare layer thereof and scatters external light incident to a surface of the antiglare film so that an image derived from the external light falling on the antiglare film's surface becomes blurred. In the case where the antiglare layer is made from particles and a binder matrix, the concave-convex structure on the surface thereof is formed due to agglutinated particles and/or respective particles which produce projections.

The inventors found that the agglutination of the particles in the binder matrix can be inhibited by adding an acrylic material having a hydroxyl group in the binder matrix, and as a result, the concave-convex structure on the surface of the antiglare layer becomes excessive so that the white-blurring can not be observed.

It seems that this is because an interaction between a carbonyl group at an acrylic site of acrylate-styrene copolymer particles and hydroxyl group in the binder matrix prevents the particles from being agglutinated, when acrylate-styrene copolymer particles are used as the particles and an acrylic material having a hydroxyl group is used in the binder matrix.

It is also a specific feature of the present invention that <b> a quotient (R_{A}/H) obtained by dividing an average diameter of the particles of an acrylate-styrene copolymer (R_{A}) by an average thickness of the antiglare layer (H) is in the range of 0.30-0.80.

In the case where the quotient (R_{A}/H) is less than 0.30, it becomes impossible to sufficiently prevent external light from falling on the antiglare film since it is difficult to form a convex-concave structure on a surface of the antiglare layer and the antiglare performance of the antiglare film decreases. In the case where the quotient (R_{A}/H) is more than 0.80, the white-blurring appears when external light falls on the antiglare layer because large convexities are formed and the convex-concave structure becomes excessive on a surface of the antiglare layer.

An antiglare film can obtain strong antiglare properties and blur an image of external light when external light falls on the antiglare film by forming large convexities on the surface of the antiglare film, which has a convex-concave structure on the surface.

The average thickness of the antiglare layer (H) in this invention is an average thickness of the antiglare layer having a concave-convex structure on the surface. This average thickness can be measured with an electronic micrometer or an automated microfigure measuring instrument. The average diameter of the acrylate-styrene copolymer can be measured with a light scattering particle size distribution analyzer.

It is also a feature of the present invention that <c> a product ((n_{A}−n_{M})×w_{A}/w_{M}) obtained by multiplying a difference between the refractive index of the particles (n_{A}) and the average refractive index of the binder matrix (n_{M}) by a quotient dividing the content of the particles in the antiglare layer (w_{A}) by the content of the binder matrix in the antiglare layer (w_{M}) is in the range of In the case where the ((n_{A}−n_{M})×w_{A}/w_{M}) is less than 0.0014, it becomes impossible to sufficiently prevent external light from falling on the antiglare film since it is difficult to form a convex-concave structure on a surface of the antiglare layer and the antiglare performance of the antiglare film decreases. In the case where the ((n_{A}−n_{M})×w_{A}/w_{M}) is more than 0.003, the acrylate-styrene copolymer particles tend to be unevenly distributed when forming the antiglare layer and an interval between adjacent convexities of the concave-convex structure formed on the antiglare layer by the acrylate-styrene copolymer particles increases. In such a case, the antiglare layer eventually has a citrus-skin-like appearance.

A difference in refractive index (n_{A}−n_{M}) between the acrylate-styrene copolymer particles (n_{A}) and the binder matrix (n_{M}) is indicative of compatibility of the acrylate-styrene copolymer particles and the binder matrix. This is because the difference in refractive index (n_{A}−n_{M}) becomes large as the acrylic component of the acrylate-styrene copolymer particles increases, while the difference in refractive index (n_{A}−n_{M}) becomes small as the styrene component of the acrylate-styrene copolymer particles increases. Hence, the smaller the difference in refractive index (n_{A}−n_{M}), the higher the compatibility of the acrylate-styrene copolymer particles and the binder matrix, while the larger the difference in refractive index (n_{A}−n_{M}), the more unevenly the acrylate-styrene copolymer particles tend to be distributed in the binder matrix. The higher a ratio by weight of the acrylate-styrene copolymer particles in the binder matrix (w_{A}/w_{M}), the more unevenly the acrylate-styrene copolymer particles tend to be distributed in the binder matrix.

The inventors have succeeded in manufacturing an antiglare film having sufficient antiglare properties and no citrus-skin-appearance by making a parameter of ((n_{A}−n_{M})×w_{A}/w_{M}), which is obtained by multiplying the difference in refractive index between the acrylate-styrene copolymer particles and the binder matrix (n_{A}−n_{M}) by the ratio by weight of the acrylate-styrene copolymer particles in the binder matrix (w_{A}/w_{M}), in the range of 0.0014-0.0030.

The refractive index of the binder matrix in this invention refers to a refractive index of the binder matrix film after a coating liquid including the binder matrix is formed into a film. In other words, the refractive index of the binder matrix is a refractive index means the refractive index of a portion of the antiglare layer other than a portion of the acrylate-styrene copolymer particles. The refractive index of the binder matrix (n_{M}) and the refractive index of the acrylate-styrene copolymer particles (n_{A}) can be measured by the Becke line detecting method (or immersion method).

The inventors have obtained an antiglare film and its application to a transmission type LCD by making <a> the antiglare layer include a binder matrix and acrylate-styrene copolymer particles, and the binder matrix include an acrylic material having a hydroxyl group; <b> a quotient (R_{A}/H) obtained by dividing an average diameter of the particles of an acrylate-styrene copolymer (R_{A}) by an average thickness of the antiglare layer (H) be in the range of 0.30-0.80; and <c> a product ((n_{A}−n_{M})×w_{A}/w_{M}) obtained by multiplying a difference between the refractive index of the particles (n_{A}) and the average refractive index of the binder matrix (n_{M}) by a quotient dividing the content of the particles in the antiglare layer (w_{A}) by the content of the binder matrix in the antiglare layer (w_{M}) be in the range of 0.0014-0.0030.

In addition, it is preferable in the antiglare film of the present invention that the acrylic material having a hydroxyl group included in the binder matrix is pentaerythritol triacrylate and the antiglare layer includes 18 or more parts by weight of pentaerythritol triacrylate relative to 100 parts by weight of the binder matrix. If a content of pentaerythritol triacrylate is less than 18 parts by weight, only an insufficient effect of this invention may be realized.

In addition, it is preferable in the antiglare film of the present invention that the average thickness of the antiglare layer (H) is in the range of 3-30 μm. If the average thickness of the antiglare layer is less than 3 μm, the resultant antiglare film may have insufficient hardness to apply on a surface of a display device. If the average thickness of the antiglare layer is more than 30 μm, costs may become too high and the degree of curl of the antiglare layer may be too much, which is unsuitable for a fabrication process for an application on a surface of a display device. To be more specific, the average thickness of the antiglare layer is desirable in the range of 4-20 μm.

In addition, it is preferable in the antiglare film of the present invention that triacetyl cellulose is used as the transparent substrate. Triacetyl cellulose is preferable because of its high level of transparency and little optical anisotropy. In particular, it is desirable when the antiglare film is applied on a surface of an LCD.

In addition, it is preferable in the antiglare film of the present invention that the thickness of the transparent substrate is in the 10-100 μm range. If the thickness is less than 10 μm, the antiglare film lacks sufficient hardness and handling ability during manufacturing. If the thickness is more than 100 μm, the antiglare film lacks handling ability during manufacturing.

If necessary, a functional layer having an antireflection property, an antistatic property, an antifouling property, an electromagnetic shielding property, an infrared absorption property, an ultraviolet absorption property or a color compensation property etc. is arranged within the antiglare film of the present invention. An antireflection layer, an antistatic layer, an antifouling layer, an electromagnetic shielding layer, an infrared absorption layer, an ultraviolet absorption layer or a color compensation layer etc. are examples of such a functional layer. The functional layer can take both a single layer structure and a multilayer structure. The functional layer may provide a plurality of functions with a single layer such as, for example, an antireflection layer having an antifouling property. In addition, the functional layer can be arranged on the antiglare layer, or between the transparent substrate and the antiglare layer. A primer layer and/or an adhesive layer etc. may be arranged between any adjacent layers in the present invention in order to improve an interlayer adhesion.

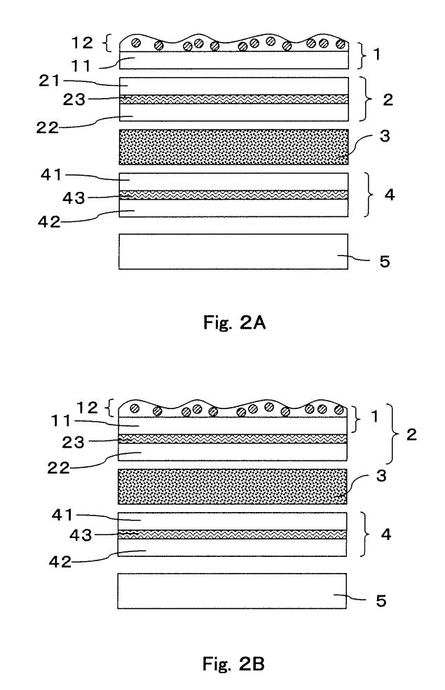

FIGS. 2A and 2B show transmission type LCDs using the antiglare film of the present invention. The transmission type LCD shown in FIG. 2A has the antiglare film (1), a polarizing plate (2), a liquid crystal cell (3), another polarizing plate (4) and a back light unit (5) in the order of this description. The side (upper side in the diagram) of the antiglare film (1) is the surface of the display which corresponds to an observer's side.

The back light unit (5) has a light source and a light diffusion plate. The liquid crystal cell (3) takes a structure of two transparent substrates one of which has an electrode, the other of which has a color filter and another electrode, and between which a liquid crystal is inserted. Each of the two polarizing plates which is arranged on and covers both sides of the liquid crystal cell (3) has two transparent substrates (21, 22, 41, 42) and a polarizing layer (23, 43) which is arranged between the transparent substrates.

The antiglare film (1) of the LCD shown in FIG. 2A has a transparent substrate (11) and a polarizing plate (2) separately. The antiglare film (1) of the LCD shown in FIG. 2B however, has a polarizing layer (23) on the opposite surface of the transparent substrate (11) from the antiglare layer so that the antiglare film (1) and the polarizing plate (2) share a single transparent substrate.

In addition, the transmission type LCD of the present invention may include other functional components. A prism sheet, a luminance improving film, a light diffusion film, which serve to efficiently use light from the back light unit, and/or a retardation film (or a phase difference film), which compensates a phase difference derived of the liquid crystal cell and/or polarizing plate etc. are examples of such other functional components. The LCD of the present invention, however, is not limited to these examples.

Next, a manufacturing method of the antiglare film of the present invention is described below.

A manufacturing method of the present invention includes coating on a transparent substrate a coating liquid containing at least a binder matrix forming material which cures by ionizing radiation, acrylate-styrene copolymer particles and a solvent in order to form a coating film on the transparent substrate, and curing the binder matrix forming material by ionizing radiation.

A glass or a plastic film can be used as the transparent substrate of the present invention. The plastic film is required to have an adequate transparency and mechanical strength. For example, polyethylene terephthalate (PET), triacetyl cellulose (TAC), diacetyl cellulose, acetylcellulose butylate, polyethylene naphthalate (PEN), a cycloolefin polymer, polyimide, polyether sulfone (PES), polymethyl methacrylate (PMMA) and polycarbonate (PC) etc. can be used as the plastic film. Among these, a triacetyl cellulose film is preferable because of low birefringence and good transparency. In particular, in the case where the antiglare film of the present invention is applied on a surface of an LCD, it is desirable that triacetyl cellulose is used as the transparent substrate. In addition, the thickness of the transparent substrate is preferred to be in the range of 10-100 μm.

In addition, it is possible to arrange a polarizing layer on the opposite surface of the transparent substrate from the antiglare layer as is shown in FIG. 2B. In this case, the polarizing layer can be made of, for example, iodine added enhanced polyvinyl alcohol and the polarizing layer is arranged between the transparent substrates.

The coating liquid for forming an antiglare layer includes at least a binder matrix forming material which cures by ionizing radiation, acrylate-styrene copolymer particles and a solvent.

In such a case, an acrylic material which is an ionizing radiation type curing material can be used as the binder matrix forming material. A polyfunctional acrylate (or methacrylate) compound such as an acrylic (or methacrylic) ester of a polyol, or a polyfunctional urethane acrylate (or methacrylate) compound which is synthesized from a diisocyanate and a hydroxy ester of a polyol and an acrylic (or methacrylic) acid can be used as the acrylic material. In addition, other than these, a polyether resin, a polyester resin, an epoxy resin, an alkyd resin, a spiroacetal resin, polybutadiene resin, a polythiol polyen resin which have an acrylic group can also be used as the ionizing radiation type curing material.

In this invention, the term “acrylate (or methacrylate)” refers to both acrylate and methacrylate. For instance, urethane acrylate (or methacrylate) compound refers to both urethane acrylate compound and urethane methacrylate compound.

As a monofunctional acrylate (or methacrylate) compound, there are, for example, 2-hydroxyethyl acrylate (or methacrylate), 2-hydroxypropyl acrylate (or methacrylate), 2-hydroxybutyl acrylate (or methacrylate), n-butyl acrylate (or methacrylate), isobutyl acrylate (or methacrylate), t-butyl acrylate (or methacrylate), glycidyl acrylate (or methacrylate), acryloyl morpholine, N-vinyl pyrrolidone, tetrahydrofurfuryl acrylate, cyclohexyl acrylate (or methacrylate), 2-ethylhexyl acrylate (or methacrylate), isobornyl acrylate (or methacrylate), isodecyl acrylate (or methacrylate), lauryl acrylate (or methacrylate), tridecyl acrylate (or methacrylate), cetyl acrylate (or methacrylate), stearyl acrylate (or methacrylate), benzyl acrylate (or methacrylate), 2-ethoxyethyl acrylate (or methacrylate), 3-methoxybutyl acrylate (or methacrylate), ethylcarbitol acrylate (or methacrylate), acrylate (or methacrylate)phosphate, ethylene oxide modified acrylate (or methacrylate)phosphate, phenoxyacrylate (or methacrylate), ethylene oxide modified phenoxyacrylate (or methacrylate), propylene oxide modified phenoxyacrylate (or methacrylate), nonylphenol acrylate (or methacrylate), ethylene oxide modified nonylphenol acrylate (or methacrylate), propylene oxide modified nonylphenol acrylate (or methacrylate), methoxydiethylene glycol acrylate (or methacrylate), methoxypolyethylene glycol acrylate (or methacrylate), methoxypropylene glycol acrylate (or methacrylate), 2-acryloyl (or methacryloyl)oxyethyl-2-hydroxypropyl phthalate, 2-hydroxy-3-phenoxypropyl acrylate (or methacrylate), 2-acryloyl (or methacryloyl)oxyethyl hydrogen phthalate, 2-acryloyl (or methacryloyl)oxypropyl hydrogen phthalate, 2-acryloyl (or methacryloyl)oxypropyl hexahydro hydrogen phthalate, 2-acryloyl (or methacryloyl)oxypropyl tetrahydro hydrogen phthalate, dimethylaminoethyl acrylate (or methacrylate), trifluoroethyl acrylate (or methacrylate), tetrafluoropropyl acrylate (or methacrylate), hexafluoropropyl acrylate (or methacrylate), octafluoropropyl acrylate (or methacrylate), and an admantane derivative monoacrylate (or monomethacrylate) such as an adamantyl acrylate (or methacrylate) having monoacrylate (or monomethacrylate) derived from 2-adamantane and adamantanediol.

As a bifunctional acrylate (or methacrylate) compound, there are diacrylate (or dimethacrylate) such as, for example, ethylene glycol diacrylate (or dimethacrylate), diethylene glycol diacrylate (or dimethacrylate), butanediol diacrylate (or dimethacrylate), hexanediol diacrylate (or dimethacrylate), nonanediol diacrylate (or dimethacrylate), ethoxylated hexanediol diacrylate (or dimethacrylate), propoxylated hexanediol diacrylate (or dimethacrylate), polyethylene glycol diacrylate (or dimethacrylate), tripropylene glycol diacrylate (or dimethacrylate), polypropylene glycol diacrylate (or dimethacrylate), neopentyl glycol diacrylate (or dimethacrylate), ethoxylated neopentyl glycol diacrylate (or dimethacrylate), tripropylene glycol diacrylate (or dimethacrylate), and hydroxypivalate neopentyl glycol diacrylate (or dimethacrylate) etc.

As a polyfunctional acrylate (or methacrylate) compound having more than two functional groups, there are, for example, triacrylates (or trimethacrylates) such as trimethylolpropane triacrylate (or trimethacrylate), ethoxylated trimethylolpropane triacrylate (or trimethacrylate), propoxylated trimethylolpropane triacrylate (or trimethacrylate), tris 2-hydroxyethyl isocyanate triacrylate (or trimethacrylate) and glycerol triacrylate (or trimethacrylate) etc., trifunctional acrylate (or methacrylate) compounds such as pentaerythritol triacrylate (or trimethacrylate), dipentaerythritol triacrylate (or trimethacrylate) and ditrimethylolpropane triacrylate (or trimethacrylate) etc., polyfunctional acrylates (or methacrylates) and their derivative compounds in which some of the acrylate groups are substituted by an alkyl group or an ε-caprolacton group such as pentaerythritol tetraacrylate (or tetramethacrylate), ditrimethylolpropane tetraacrylate (or tetramethacrylate), dipentaerythritol tetraacrylate (or tetramethacrylate), dipentaerythritol pentaacrylate (or pentamethacrylate), ditrimethylolpropane pentaacrylate (or pentamethacrylate), dipentaerythritol hexaacrylate (or hexamethacrylate) and ditrimethylolpropane hexaacrylate (or hexamethacrylate) etc.

In addition, polyols and compounds obtained by a reaction of a polyisocyanate and an acrylate having a hydroxyl group can be used as a urethane acrylate compound. Specifically, UA-306H, UA-306T and UA-3061 etc. made by Kyoeisha chemical Co., Ltd. UV-1700B, UV-6300B, UV-7600B, UV-7605B, UV-7640B and UV-7650B etc. made by Nippon Synthetic Chemical Industry Co., Ltd. U-4HA, U-6HA, UA-100H, U-6LPA, U-15HA, UA-32P and U-324A etc. made by Shin-Nakamura Chemical Co., Ltd. Ebecryl-1290, Ebecryl-1290K and Ebecryl-5129 etc. made by Daicel UCB Company Ltd. UN-3220HA, UN-3220HB, UN-3220HC and UN-3220HS etc. made by Negami Chemical Industrial Co., Ltd. can be used.

In addition, the antiglare film of the present invention contains an acrylic material having a hydroxyl group as a binder matrix forming material. Hydroxyethyl acrylate, hydroxyethyl methacrylate, pentaerythritol triacrylate or dipentaerythritol pentaacrylate can be used as the acrylic material having a hydroxyl group. In particular, it is preferable that pentaerythritol triacrylate is appropriately used.

Moreover, a thermoplastic resin may be added into the binder matrix forming material besides the acrylic material which cures by ionizing radiation. Cellulose derivatives such as acetylcellulose, nitrocellulose, acetylbutylcellulose, ethylcellulose and methylcellulose etc., vinyl resins such as vinyl acetate and its copolymers, vinyl chloride and its copolymers and vinylidene chloride and its copolymers etc., acetal resins such as polyvinyl formal and polyvinyl butylal etc. acrylic resins such as an acrylate resin and its derivatives, and a methacrylate resin and its derivatives etc., polystyrene resin, a polyamide resin, a linear polyester resin, and polycarbonate resin etc. can be used as the thermoplastic resin. It is possible to improve adhesiveness between the transparent substrate and the antiglare layer by adding a thermoplastic resin. In addition, it becomes hard for the resultant antiglare film to curl up if a thermoplastic resin is added.

(In addition, by adding a thermoplastic resin it is possible to control curling of the antiglare film to be manufactured.)

In addition, in the case where ultraviolet is used as the ionizing radiation, a photopolymerization initiator is added in the coating liquid for forming an antiglare layer. Although any heretofore known photopolymerization initiators can be used as the photopolymerization initiator, it is preferable to select one suitable for the binder matrix forming material. Benzoin and its alkyl ethers such as benzoin, benzoin mehtylether, benzoin ethylether, benzoinisopropylether and benzyl methylketal etc. can be used as the photopolymerization initiator. Usage of the photopolymerization initiator relative to 0.5 parts by weight of the binder matrix is in the range of 0.5-20 parts by weight, or more preferably in the range of 1-5 parts by weight.

Copolymer particles of methyl methacrylate (MMA) and styrene is an example of the acrylate-styrene copolymer particles. Particle-like copolymer of MMA and styrene is obtained from raw MMA and styrene by suspension polymerization. Furthermore, copolymer particles of MMA and styrene with various refractive indexes can be obtained by changing the weight ratio of raw MMA and styrene,

If necessary, a solvent is added to the coating liquid for forming an antiglare layer. The particles and the binder matrix are evenly dispersed by a solvent so that a viscosity of the coating liquid for forming an antiglare layer when coating on the transparent substrate becomes adjustable within an appropriate range.

In the case where triacetyl cellulose is used as the transparent substrate and the antiglare layer is directly formed on the triacetyl cellulose film without arranging any functional layer in the present invention, it is preferable in the present invention that a mixed solvent of combined solvents in which triacetyl cellulose film is and is not dissolved or swollen is used as a solvent for the coating liquid for forming an antiglare layer. If this mixed solvent is used, the antiglare film is able to have sufficient adhesiveness between the antiglare layer and the triacetyl cellulose film at their interface.

In such a case, as the solvent in which the triacetyl cellulose film is dissolved or swollen, there are ethers such as dibutylether, dimethoxymethane, dimethoxyethane, diethoxyethane, propylene oxide, dioxane, dioxolane, trioxane, tetrahydrofuran, anisole and phenetol etc., some ketones such as acetone, methyl ethyl ketone, diethyl ketone, dipropyl ketone, diisobutyl ketone, cyclopentanone, cyclohexanone, methyl cyclohexanone and ethyl cyclohexanone etc., esters such as ethyl formate, propyl formate, n-pentyl formate, methyl acetate, ethyl acetate, methyl propionate, ethyl propionate, n-pentyl acetate and γ-butyrolactone etc., and cellosolves such as methyl cellosolve, cellosolve, butyl cellosolve and cellosolve acetate etc. A single one of these alone or any combination of a plurality of these together can be used as the solvent.

Above all, cyclic ether, which has an ether bond and forms a ring in a molecule, is preferably used as the solvent in which the triacetyl cellulose film is dissolved or swollen. Acrylate-styrene copolymer particles are used as the particles in the antiglare film of the present invention. Cyclic ether prevents the acrylate-styrene copolymer particles from agglutination and uneven distribution in the binder matrix so that a resultant concave-convex structure of a surface of the antiglare layer becomes excessive and the antiglare film shows no white-blurring and has no citrus-skin-like appearance. Dioxane, dioxolan, trioxane and tetrahydrofuran are available as the cyclic ether.

As the solvent in which the triacetyl cellulose film is not dissolved or swollen, there are aromatic hydrocarbons such as toluene, xylene, cyclohexane and cyclohexylbenzene etc., hydrocarbons such as n-hexane etc., and some ketones such as methyl isobutyl ketone and methyl butyl ketone. One of these alone or any combination of these together can be used as the solvent.

A surface conditioner may be added to the coating liquid for forming an antiglare layer in the present invention in order to avoid occurrence of defects such as repellency and unevenness on the antiglare layer. The surface conditioner decreases surface tension of the coating liquid for forming an antiglare layer and may also be called a leveling agent, an antifoam agent, an interface tension conditioner or a surface tension conditioner.

A silicone series additive, a fluorinated compound additive or an acrylic additive is ordinarily used as a surface conditioner. Derivative compounds having a basic structure of polydimethylsiloxane and a modified side chain are used for the silicone series additive. For example, polyether modified dimethylsiloxane is used as the silicone series additive. Compounds having a perfluoroalkyl group are used for the fluorinated compound additive. Polymers having a basic unit of an acrylic monomer, a methacrylic monomer and/or a styrene monomer are used for the acrylic additive. In addition, the acrylic additive may include an alkyl group, a polyether group, a hydroxyl group and/or an epoxy group in a side chain as well as polymerized acrylic monomer, methacrylic monomer and/or styrene monomer in a main chain.

In addition, the coating liquid for forming an antiglare layer in the present invention may include other functional additives besides the surface conditioner. It is preferable, however, that these other additives have little influence on the transparency and light diffusion of the antiglare layer. An antistat, an ultraviolet absorber, an infrared absorber, an antifouling agent, a repellant, a refractive index adjuster, an adhesion improver and a curing agent etc. can be used as the other functional additives. Then, the resultant antiglare layer can have additional properties such as antistatic properties, ultraviolet absorbing properties, infrared absorbing properties, antifouling properties and water repelling properties etc. as well as antiglare properties by their usage.

The forming liquid for forming an antiglare layer is coated on the transparent substrate and forms a coated layer. Coating techniques employing a roll coater, a reverse roll coater, a gravure coater, a knife coater, a bar coater, and a die coater can be used for coating the coating liquid for forming an antiglare layer on the transparent substrate. Above all, it is preferable to use a die coater since it becomes possible to coat by a high speed roll to roll process. The desired solid content concentration of the coating liquid varies depending on the coating process. The concentration usually results in 30-70% by weight.

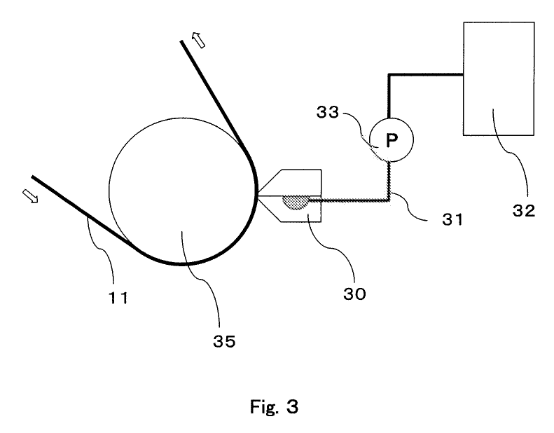

Next, a coating apparatus employing a die coater in the present invention is described. FIG. 3 shows an exemplary diagram of the coating apparatus employing a die coater in the present invention. A die head 30 is connected to a tank of coating liquid 32 with pipework 31 in the coating apparatus so that the coating liquid for forming an antiglare layer in the tank of coating liquid 32 is transferred into the die head 30 by a liquid transfer pump 33. The coating liquid for forming an antiglare layer transferred to the die head 30 is spat out from a slit space and a coated layer is formed on the transparent substrate 11. Using rolled up transparent substrate 11 and a rotary roll 35, a coated layer can be formed continuously on the transparent substrate by a roll to roll process.

The resultant coated layer is exposed to ionizing radiation to form the antiglare layer. Ultraviolet light and electron beams can be used as the ionizing radiation. In the case where ultraviolet light is used, a high pressure mercury lamp, a low pressure mercury lamp, an ultra-high pressure mercury lamp, a metal halide lamp, carbon arc or xenon arc can be used as a light source. In the case where electron beams are used, electron beams from various electron accelerators such as Cockcroft-Walton accelerator, van de Graaff accelerator, resonant transformer accelerator, insulated core transformer accelerator, linear accelerator, dynamitron accelerator, or high frequency accelerator can be used. The electron beams are preferred to have energy of 50-1000 keV. It is more preferable if the electron beams have energy in the range of 110-300 keV.

A drying process may be arranged before and/or after forming the antiglare layer. In addition, curing and drying may be performed simultaneously. Particularly, in the case where the coating liquid contains a solvent as well as the binder matrix and the particles, it is necessary to arrange a drying process before exposing to ionizing radiation in order to remove the solvent. For example, heating, blowing air and hot air are available as the drying method.

### EXAMPLES

Examples are described below.

### Example 1

A triacetyl cellulose film (TD-80U by Fuji Photo Film Corp.) was used as a transparent substrate. 94.5 parts by weight of a pentaerythritol triacrylate having a hydroxyl group in a molecule (PE3A: Acrylic material 1A) as the binder matrix forming material, 5.0 parts by weight of Irgacure 184 (by Ciba Japan K.K.) as a polymerization initiator, and 0.5 parts by weight of BYK 350 (by BYK-Chemie Japan K.K.) as an acrylic additive were used as the coating liquid for forming an antiglare layer. In addition, 9.0 parts by weight of acrylate-styrene copolymer particles with 6.0 μm of average diameter and 1.560 of refractive index were used as the acrylate-styrene copolymer particles. These acrylate-styrene copolymer particles were copolymer particles of MMA and styrene. Further, a mixed solvent of 30 parts by weight of dioxolan and 70 parts by weight of toluene was used as the solvent.

The coating liquid for forming an antiglare layer, which was prepared from the binder matrix forming material, the acrylate-styrene copolymer particles and the solvent stated above, was coated on the triacetyl cellulose film by a coating apparatus employing a die coater to obtain a coated layer. After drying to remove the solvent contained in the coated layer, the layer was cured by exposure to 400 mJ/cm² of ultraviolet radiation from a high pressure mercury lamp so that an antiglare film having an antiglare layer on a triacetyl cellulose film was fabricated.

### Example 2-8 and Comparative Example 1-15

Various coating liquids for forming an antiglare layer were prepared by using not only PE3A (Acrylic material 1A), which had a hydroxyl group in the molecule, but also dipentaerythritol hexaacrylate (DPHA: Acrylic material 1B), which had no hydroxyl group in the molecule, in the binder matrix forming material, and adjusting their mixing ratio, and further, the average diameter (R_{A}), the refractive index (n_{A}) and content (w_{A}) of the acrylate-styrene copolymer particles as is shown in table 1A and 1B. Similar to the case in example 1, antiglare films which had each antiglare layer on triacetyl cellulose films were fabricated using these coating liquids for forming an antiglare layer. It is noted that no PE3A (Acrylic material 1A) was used in comparative example 15.

Table 1A and 1B show each composition of the coating liquids for forming an antiglare layer as well as average thickness of the antiglare layer (H) in example 1-8 and comparative example 1-15. The average thickness was measured with an electronic micrometer K351 (manufactured by Anritsu Corp.). In addition, the average diameter of the acrylate-styrene copolymer particles was measured with a light scattering particle size distribution analyzer SALD-7000 (manufactured by Shimadzu Corp.). The refractive index of the acrylate-styrene copolymer particles was measured by Becke line detecting method (or immersion method). The refractive index of the binder matrix was measured by Becke line detecting method (or immersion method) using a sample which was obtained in such a way that the binder matrix forming material separated from the acrylate-styrene copolymer particles was coated, dried and cured by exposure to an ultraviolet ray.

TABLE 1A

| | Binder matrix forming material | | | | | |
|---|---|---|---|---|---|---|
| | Acrylic | Acrylic | Polymerization | Acrylic | Total | Refractive |
| | material 1A | material 1B | initiator | additive | weight | index of the |
| | PE3A | DPHA | Irgacure184 | BYK350 | w_{M} | binder |
| | [parts by | [parts by | [parts by | [parts by | [parts by | matrix |
| | weight] | weight] | weight] | weight] | weight] | n_{M} |
| Example 1 | 94.5 | — | 5.0 | 0.5 | 100.0 | 1.530 |
| Comparative | 56.7 | 37.8 | 5.0 | 0.5 | 100.0 | 1.530 |
| example 1 | | | | | | |
| Comparative | 56.7 | 37.8 | 5.0 | 0.5 | 100.0 | 1.530 |
| example 2 | | | | | | |
| Comparative | 56.7 | 37.8 | 5.0 | 0.5 | 100.0 | 1.530 |
| example 3 | | | | | | |
| Comparative | 56.7 | 37.8 | 5.0 | 0.5 | 100.0 | 1.530 |
| example 4 | | | | | | |
| Example 2 | 56.7 | 37.8 | 5.0 | 0.5 | 100.0 | 1.530 |
| Comparative | 56.7 | 37.8 | 5.0 | 0.5 | 100.0 | 1.530 |
| example 5 | | | | | | |
| Example 3 | 56.7 | 37.8 | 5.0 | 0.5 | 100.0 | 1.530 |
| Comparative | 56.7 | 37.8 | 5.0 | 0.5 | 100.0 | 1.530 |
| example 6 | | | | | | |
| Comparative | 56.7 | 37.8 | 5.0 | 0.5 | 100.0 | 1.530 |
| example 7 | | | | | | |
| Example 4 | 56.7 | 37.8 | 5.0 | 0.5 | 100.0 | 1.530 |
| Comparative | 56.7 | 37.8 | 5.0 | 0.5 | 100.0 | 1.530 |
| example 8 | | | | | | |
| Comparative | 56.7 | 37.8 | 5.0 | 0.5 | 100.0 | 1.530 |
| example 9 | | | | | | |
| Comparative | 56.7 | 37.8 | 5.0 | 0.5 | 100.0 | 1.530 |
| example 10 | | | | | | |
| Example 5 | 56.7 | 37.8 | 5.0 | 0.5 | 100.0 | 1.530 |
| Comparative | 56.7 | 37.8 | 5.0 | 0.5 | 100.0 | 1.530 |
| example 11 | | | | | | |
| Example 6 | 56.7 | 37.8 | 5.0 | 0.5 | 100.0 | 1.530 |
| Comparative | 56.7 | 37.8 | 5.0 | 0.5 | 100.0 | 1.530 |
| example 12 | | | | | | |
| Comparative | 56.7 | 37.8 | 5.0 | 0.5 | 100.0 | 1.530 |
| example 13 | | | | | | |
| Example 7 | 56.7 | 37.8 | 5.0 | 0.5 | 100.0 | 1.530 |
| Comparative | 56.7 | 37.8 | 5.0 | 0.5 | 100.0 | 1.530 |
| example 14 | | | | | | |
| Example 8 | 18.9 | 75.6 | 5.0 | 0.5 | 100.0 | 1.530 |
| Comparative | — | 95.0 | 5.0 | 0.5 | 100.0 | 1.530 |
| example 15 | | | | | | |

TABLE 1B

| | | | | | | Average |
|---|---|---|---|---|---|---|
| | Acrylate-styrene copolymer particles | | | | | thickness |
| | Average | | | Solvent | | of |
| | diameter | w_{A} | | Dioxolan | Toluene | antiglare |
| | R_{A} | [parts by | Refractive index | [parts by | [parts by | layer H |
| | [μm] | weight] | n_{A} | weight] | weight] | [μm] |
| Example 1 | 6.0 | 9.0 | 1.560 | 30 | 70 | 10.0 |
| Comparative | 6.0 | 9.0 | 1.500 | 30 | 70 | 10.0 |
| example 1 | | | | | | |
| Comparative | 6.0 | 4.0 | 1.520 | 30 | 70 | 10.0 |
| example 2 | | | | | | |
| Comparative | 6.0 | 24.0 | 1.535 | 30 | 70 | 10.0 |
| example 3 | | | | | | |
| Comparative | 6.0 | 10.0 | 1.540 | 30 | 70 | 10.0 |
| example 4 | | | | | | |
| Example 2 | 6.0 | 24.0 | 1.540 | 30 | 70 | 10.0 |
| Comparative | 6.0 | 40.0 | 1.540 | 30 | 70 | 10.0 |
| example 5 | | | | | | |
| Example 3 | 4.0 | 12.0 | 1.550 | 30 | 70 | 6.0 |
| Comparative | 6.0 | 10.0 | 1.550 | 30 | 70 | 4.0 |
| example 6 | | | | | | |
| Comparative | 6.0 | 4.0 | 1.550 | 30 | 70 | 10.0 |
| example 7 | | | | | | |
| Example 4 | 6.0 | 12.0 | 1.550 | 30 | 70 | 10.0 |
| Comparative | 6.0 | 18.0 | 1.550 | 30 | 70 | 10.0 |
| example 8 | | | | | | |
| Comparative | 6.0 | 35.0 | 1.550 | 30 | 70 | 10.0 |
| example 9 | | | | | | |
| Comparative | 6.0 | 12.0 | 1.550 | 30 | 70 | 25.0 |
| example 10 | | | | | | |
| Example 5 | 8.0 | 12.0 | 1.550 | 30 | 70 | 12.0 |
| Comparative | 6.0 | 4.0 | 1.560 | 30 | 70 | 10.0 |
| example 11 | | | | | | |
| Example 6 | 6.0 | 9.0 | 1.560 | 30 | 70 | 10.0 |
| Comparative | 6.0 | 12.0 | 1.560 | 30 | 70 | 10.0 |
| example 12 | | | | | | |
| Comparative | 6.0 | 8.0 | 1.560 | 30 | 70 | 6.0 |
| example 13 | | | | | | |
| Example 7 | 6.0 | 6.0 | 1.570 | 30 | 70 | 10.0 |
| Comparative | 6.0 | 12.0 | 1.580 | 30 | 70 | 10.0 |
| example 14 | | | | | | |
| Example 8 | 6.0 | 24.0 | 1.540 | 30 | 70 | 10.0 |
| Comparative | 6.0 | 24.0 | 1.540 | 30 | 70 | 10.0 |
| example 15 | | | | | | |

“Antiglare properties”, “White-blurring” and “Citrus-skin-like appearance” of the antiglare film obtained in example 1-8 and comparative example 1-15 were evaluated in the following way.

### “Antiglare Property” Evaluation:

The antiglare films obtained in example 1-8 and comparative example 1-15 were pasted on a black plastic plate with a tackiness agent (adhesive) and observed for visual evaluation from a point 1 m away. The results were expressed as follows. Double circle: The image of the observer was completely blurred and could not be recognized. Circle: The image of the observer was perceivable but not so clear. Cross: The image of the observer was clearly reflected.

### “White-Blurring” Evaluation:

The antiglare films obtained in example 1-8 and comparative example 1-15 were pasted on a black plastic plate with tackiness agent (adhesive) and light from a fluorescent lamp was reflected on the films. Light diffusions by the antiglare films were visually evaluated. The results were expressed as follows. Circle: Light diffusion by the antiglare film was little so that the film was not significantly whitened. Cross: The film was whitened to an unacceptable level.

### “Citrus-Skin-Like Appearance” Evaluation:

The antiglare films obtained in example 1-8 and comparative example 1-15 were pasted on a black plastic plate with tackiness agent (adhesive) and visually observed for a citrus-skin-like appearance. The results were expressed as follows. Circle: An antiglare film visually appeared to have a smooth and flat surface. Cross: The film had a strong citrus-skin-like appearance and was not acceptable.

Table 2 shows evaluation results on “Antiglare properties”, “White-blurring” and “Citrus-skin-like appearance” of the antiglare films obtained in example 1-8 and comparative example 1-15. In addition, table 2 also shows a quotient (R_{A}/H) obtained by dividing the average diameter of the acrylate-styrene copolymer particles (R_{A}) by the average thickness of the antiglare layer (H), and a product ((n_{A}−n_{M})×w_{A}/w_{M}) obtained by multiplying a difference between the refractive index of the acrylate-styrene copolymer particles and the average refractive index of the binder matrix (n_{A}−n_{M}) by a quotient of dividing the content of the acrylate-styrene copolymer particles (w_{A}) by the content of the binder matrix (w_{M}).

TABLE 2

| | | | Evaluation result | | |
|---|---|---|---|---|---|
| | | | Antiglare | | Citrus-skin-like |
| | R_{A}/H | (n_{A} − n_{M}) × w_{A}/w_{M} | properties | White-blurring | appearance |
| Example 1 | 0.60 | 0.0029 | ◯ | ◯ | ◯ |
| Comparative | 0.60 | −0.0029 | X | ◯ | ◯ |
| example 1 | | | | | |
| Comparative | 0.60 | −0.0004 | X | ◯ | ◯ |
| example 2 | | | | | |
| Comparative | 0.60 | 0.0013 | X | ◯ | ◯ |
| example 3 | | | | | |
| Comparative | 0.60 | 0.0011 | X | ◯ | ◯ |
| example 4 | | | | | |
| Example 2 | 0.60 | 0.0025 | ◯ | ◯ | ◯ |
| Comparative | 0.60 | 0.0042 | ◯ | ◯ | X |
| example 5 | | | | | |
| Example 3 | 0.67 | 0.0025 | ◯ | ◯ | ◯ |
| Comparative | 1.50 | 0.0021 | ⊚ | X | ◯ |
| example 6 | | | | | |
| Comparative | 0.60 | 0.0008 | X | ◯ | ◯ |
| example 7 | | | | | |
| Example 4 | 0.60 | 0.0025 | ◯ | ◯ | ◯ |
| Comparative | 0.60 | 0.0038 | ◯ | ◯ | X |
| example 8 | | | | | |
| Comparative | 0.60 | 0.0074 | ⊚ | X | X |
| example 9 | | | | | |
| Comparative | 0.24 | 0.0025 | X | ◯ | ◯ |
| example 10 | | | | | |
| Example 5 | 0.67 | 0.0025 | ◯ | ◯ | ◯ |
| Comparative | 0.60 | 0.0013 | X | ◯ | ◯ |
| example 11 | | | | | |
| Example 6 | 0.60 | 0.0029 | ◯ | ◯ | ◯ |
| Comparative | 0.60 | 0.0038 | ◯ | ◯ | X |
| example 12 | | | | | |
| Comparative | 1.00 | 0.0025 | ◯ | X | ◯ |
| example 13 | | | | | |
| Example 7 | 0.60 | 0.0025 | ⊚ | ◯ | ◯ |
| Comparative | 0.60 | 0.0063 | ⊚ | ◯ | X |
| example 14 | | | | | |
| Example 8 | 0.60 | 0.0025 | ◯ | ◯ | ◯ |
| Comparative | 0.60 | 0.0025 | ◯ | X | ◯ |
| example 15 | | | | | |

As a result of the examples described above, the antiglare film obtained in example 1-8 had higher antiglare properties than the antiglare film obtained in comparative example 1-15 as well as no citrus-skin-like appearance and no white-blurring.

What is claimed is:

1. An antiglare film comprising:
a transparent substrate; and
an antiglare layer, said antiglare layer being arranged on said transparent substrate, said antiglare layer having a concave-convex structure on the opposite side from said transparent substrate, and including acrylate-styrene copolymer particles and a binder matrix, said binder matrix including an acrylic material having a hydroxyl group, a quotient R_{A}/H obtained by dividing the average diameter of said acrylate-styrene copolymer particles (R_{A}) by the average thickness of said antiglare layer (H) being in the range of 0.30-0.80, and a product (n_{A}−n_{M})×w_{A}/w_{M} obtained by multiplying a difference between the refractive index of said acrylate-styrene copolymer particles and the average refractive index of said binder matrix (n_{A}−n_{M}) by a quotient of dividing the content of said acrylate-styrene copolymer particles (w_{A}) by the content of said binder matrix (w_{M}) being in the range of 0.0015-0.003.

2. The antiglare film according to claim 1, wherein said acrylic material having a hydroxyl group is pentaerythritol triacrylate, and said antiglare layer includes more than 18 parts by weight of said acrylic material having a hydroxyl group relative to 100 parts by weight of said binder matrix.

3. The antiglare film according to claim 1, wherein the average thickness of said antiglare layer (H) is in the range of 3-30 μm.

4. The antiglare film according to claim 2, wherein the average thickness of said antiglare layer (H) is in the range of 3-30 μm.

5. The antiglare film according to claim 1, wherein said transparent substrate is a triacetyl cellulose film.

6. The antiglare film according to claim 4, wherein said transparent substrate is a triacetyl cellulose film.

7. The antiglare film according to claim 1, wherein the thickness of said transparent substrate is in the range of 10-100 μm.

8. The antiglare film according to claim 6, wherein the thickness of said transparent substrate is in the range of 10-100 μm.

9. A transmission type LCD comprising:
said antiglare film according to claim 1;
a first polarizing plate;
a liquid crystal cell;
a second polarizing plate; and
a back light unit
in the order of this description from an observer's side,
said antiglare layer being arranged on the surface of said observer's side.

10. A transmission type LCD comprising:
said antiglare film according to claim 5;
a first polarizing plate;
a liquid crystal cell;
a second polarizing plate; and
a back light unit
in the order of this description from an observer's side,
said antiglare layer being arranged on the surface of said observer's side.

11. A transmission type LCD comprising:
said antiglare film according to claim 7;
a first polarizing plate;
a liquid crystal cell;
a second polarizing plate; and
a back light unit
in the order of this description from an observer's side,
said antiglare layer being arranged on the surface of said observer's side.

12. A transmission type LCD comprising:
said antiglare film according to claim 8;
a first polarizing plate;
a liquid crystal cell;
a second polarizing plate; and
a back light unit
in the order of this description from an observer's side,
said antiglare layer being arranged on the surface of said observer's side.

13. A polarizing plate comprising:
said antiglare film according to claim 1;
a polarizing layer; and
a second transparent substrate
in the order of this description,
said polarizing layer being arranged on the opposite side of said transparent substrate of said antiglare film from a side on which said antiglare layer is formed.

14. A polarizing plate comprising:
said antiglare film according to claim 7;
a polarizing layer; and
a second transparent substrate
in the order of this description,
said polarizing layer being arranged on the opposite side of said transparent substrate of said antiglare film from a side on which said antiglare layer is formed.

15. A polarizing plate comprising:
said antiglare film according to claim 8;
a polarizing layer; and
a second transparent substrate
in the order of this description,
said polarizing layer being arranged on the opposite side of said transparent substrate of said antiglare film from a side on which said antiglare layer is formed.

16. A transmission type LCD comprising:
said polarizing plate according to claim 13;
a liquid crystal cell;
a second polarizing plate; and
a back light unit
in the order of this description from an observer's side,
said antiglare layer being arranged on the surface of said observer's side.

17. A transmission type LCD comprising:
said polarizing plate according to claim 15;
a liquid crystal cell;
a second polarizing plate; and
a back light unit
in the order of this description from an observer's side,
said antiglare layer being arranged on the surface of said observer's side.

18. A manufacturing method of an antiglare film having particles in a binder matrix on a transparent substrate comprising:
coating a coating liquid for forming an antiglare layer which includes said binder matrix, acrylate-styrene copolymer particles and a solvent to form a coated layer;
drying said coated layer to remove said solvent; and
curing a binder matrix forming material to form said binder matrix by exposing said coated layer to ionizing radiation, said binder matrix forming material including an acrylic material having a hydroxyl group, a quotient R_{A}/H obtained by dividing the average diameter of said acrylate-styrene copolymer particles (R_{A}) by the average thickness of said antiglare layer (H) being in the range of 0.30-0.80, and a product (n_{A}−n_{M})×w_{A}/w_{M} obtained by multiplying a difference between the refractive index of the acrylate-styrene copolymer particles and the average refractive index of the binder matrix (n_{A}−n_{M}) by a quotient of dividing the content of the acrylate-styrene copolymer particles (w_{A}) by the content of the binder matrix (w_{M}) being in the range of 0.0015-0.003.

19. The manufacturing method according to claim 18, wherein said transparent substrate is a triacetyl cellulose film, and said solvent, which is included in said coating liquid for forming said antiglare layer, includes a mixed solvent of a solvent in which said triacetyl cellulose film is dissolved or swollen and a solvent in which said triacetyl cellulose film is not dissolved or swollen.

20. The manufacturing method according to claim 19, wherein said solvent in which said triacetyl cellulose film is dissolved or swollen includes a cyclic ether compound.
